(19) United States
(12) Patent Application Publication
(10) Pub. No.: US 2019/0107453 A1
(43) Pub. Date: Apr. 11, 2019

(54) Identification and Use of Air Lift for Heavier than Air Aerial Vehicles

(71) Applicant: Teddy Gilaad, Zichron Yaakov (IL)

(72) Inventor: Teddy Gilaad, Zichron Yaakov (IL)

(21) Appl. No.: 15/871,391

(22) Filed: Jan. 15, 2018

Related U.S. Application Data
(60) Provisional application No. 62/568,506, filed on Oct. 5, 2017.

(51) Int. Cl. G01L 5/18; G01P 3/62; G05D 1/06; B64D 43/02; B64C 13/18; B64C 13/20; G05D 1/10; G05D 1/00; G01L 5/00; G01L 1/26

(52) U.S. Cl. CPC G01L 5/18; G01P 3/62; G05D 1/0607; B64D 43/02; G01L 1/26; B64C 13/20; G05D 1/104; G05D 1/0027; G01L 5/0052; B64C 13/18

(57) ABSTRACT

Systems and methods are disclosed for automatically detecting better lift and using the lift to stay aloft longer, provide recommendation to the aerial vehicle's pilot or fully controlling the flight of the aerial vehicle. The disclosed techniques pertain to aerial vehicles such as airplanes or model airplanes, gliders or model gliders, sailplanes or model sailplanes, hang-gliders, paragliders, speedflying, parafoils etc. The invention uses sensors located on the aerial vehicle to gauge air lift (updraft, thermal, ridge lift etc.) to extend the time the aerial vehicle may be kept aloft. The data flowing from the sensors is fed into a computer, that may provide recommendations to the pilot or to the autopilot (Computer) of the best path to take, to find better lift and to stay aloft.

### RELATED APPLICATION

This application is related to and claims priority from U.S. provisional application Ser. No. 62/568,506, filed on Oct. 5, 2017 and entitled “A Method to Better Identify Air Lift and Better Use This Air Lift for Heavier Than the Air, Aerial Vehicles.” The foregoing application is incorporated herein in its entirety for all that it teaches and discloses without exclusion of any portion thereof.

### TECHNICAL FIELD

The present disclosure is related to aerial vehicles, and, more particularly is related to identification and use of lift during the flight of such vehicles.

### BACKGROUND

Currently available technical apparatus to identify lift in the air is a commercially available apparatus called “Variometer”, also known as Vertical Speed Indicator—VSI. Lift is caused by air mass streaming up, lifting the Aerial Vehicles flying within it. Variometer is an ‘air pressure change’ sensor, changes which are caused by change of altitude or by air lift streaming up (Sometimes call “Updraft”—air streaming up, such as thermal). This apparatus then provides a visual and/or audible indication to the pilot, on the type of the change (lift=up or lower=down) and the rate of gaining or losing height (meters per second, etc.). Such Variometer or VSI is installed in almost every commercial Arial Vehicle, in any Glider and the vast majority of the hang-gliders & paragliding pilots buy a Variometer instrument and use it during flight, as it is a great tool to identify lift and help pilots stay aloft more time than without it.

A Variometer can indicate lift or lower, but cannot provide information about where a stronger lift is. It just indicates that it senses lift or lower. It is common method by unpowered aerial vehicle pilots to start turning when the variometer indicate lift, to stay within the lift and not cross it, flying as storks do—in a circular or helical path, within lift (such as a thermal). As used herein, the term “unpowered” encompasses a craft flying without power, whether or not the craft has power available to it.

Experienced unpowered aerial vehicle pilots can sometimes identify the direction to the lift core for thermals by sensing it in their seats, e.g., by sensing the movement of the aerial vehicle. Because of this, experienced unpowered aerial vehicle pilots generally stay aloft longer time than novice pilots, who have not learned to feel the lift. There are currently no known technical solutions to point the pilot to the highest lift (such as the thermal core or peak ridge lift etc.), or even stay in the lift and not to lose it, so most pilots have shorter flights, because losing lift will result losing height and will imply a shorter flight.

The basic lift sensing elements is a variometer sensor (AKA Vertical Speed Indicator). It is a commercially available device. It is noted to make the point that the Variometer Sensor is composed of 2 main parts: A simple air pressure sensor and an analog or digital, mechanical or electronic “calculating” device that report the air pressure change rate over time (lift or lower) in the data it gets from the pressure sensor. Since a Variometer sensor is much more expensive than a simple pressure sensor and since the Aerial Vehicle is equipped with an on-board computer, air pressure change over time may be calculated by this computer, so a simple air pressure may be used anywhere a Variometer sensor is mentioned in this paper, to lower the cost of the solution.

Before proceeding to the remainder of this disclosure, it should be appreciated that the disclosure may address some of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to be, to accurately catalog, or to comprehensively summarize any prior art reference or practice. As such, the inventors expressly disclaim this section as admitted or assumed prior art. Moreover, the identification or implication herein of one or more desirable courses of action reflects the inventors' own observations and ideas, and should not be assumed to indicate an art-recognized desirability.

### SUMMARY

As noted above, the innovations described herein pertain to heavier than air aircraft, which may be powered or unpowered, manned or un-manned. Examples include airplanes or model airplanes, gliders or model gliders (with or without motor), sailplane or model sailplanes (both with or without motor), hang-gliders, paragliders (with or without motor), speedflying craft, parafoils and other crafts. Aerial vehicles of these types may be hereinafter referred to as “aerial vehicles” or “heavier than the air” aerial vehicles. More particularly, the present invention is in the technical field of better identifying (compared to other methods available today) air lift and better use that lift, to gain more height. The optional motor and propeller is defined here, to be activated, when low lift conditions are present. This invention covers not only recommendation to an on board human pilot, but also proposes a fully autonomous aerial vehicles (Manned or un-manned) that uses this invention to stay aloft.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic diagram showing basic sensors location in an implementation of one or more embodiments of the disclosed principles;

FIG. 2 is a schematic diagram showing extended sensor locations for improved lift map generation, wherein the additional sensors are located on foldable extending rods or wires to create a wider and more detailed lift map;

FIG. 3 is an example diagram showing one side of the aerial vehicle entering lift, e.g., a thermal, as an example of how lift is detected, the lift map is created and the recommendation to the pilot or autopilot is produced, wherein at this stage, no action need be taken, the system just gauges and checks that it actually is a thermal detected, meaning the pressure is getting lower;

FIG. 4 is an example diagram showing the aerial vehicle as it passes the lift center in an example of how lift is detected, the lift map is created and the recommendation to the pilot or autopilot is produced, wherein, in the illustrated scenario, the aerial vehicle should turn right to stay within the thermal;

FIG. 5 is a schematic diagram showing the aerial vehicle spinning within lift (e.g., thermal), gaining height, tracing an optimal circle the aerial vehicle traces based on the recommendation delivered to the pilot or commands sourced from autopilot; and

FIG. 6 is a ridge lift diagram showing ridge lift areas created when wind impacts a ridge from the left and is diverted upward, following the ridge outline.

### DETAILED DESCRIPTION

Before presenting a detailed discussion of embodiments of the disclosed principles, some basic lift theory and an overview of certain embodiments is given to aid the reader in understanding the later discussion. As an initial matter, unpowered aerial vehicles stay aloft by using air lift, such as thermal lift or ridge lift. A thermal, which is the most common lift source in unpowered flights, is a column of air that streams upward because it is hotter than surrounding air, and the upper air layers are even cooler. A thermal typically has a round or similar to round cross section, with a diameter ranging from a few meters up to a few kilometers.

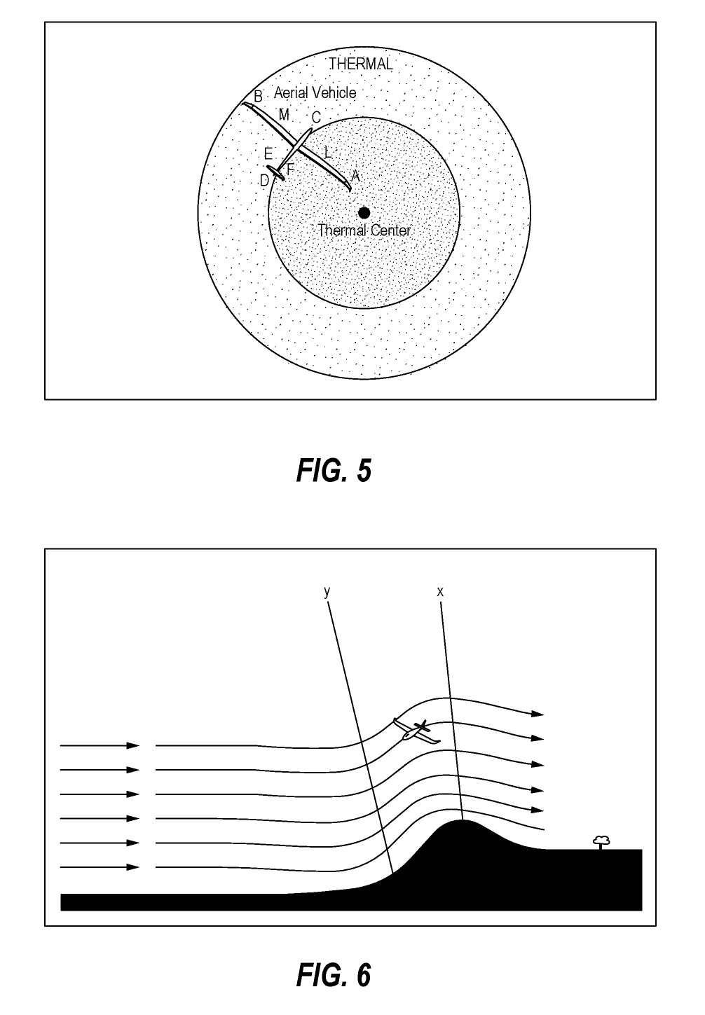

A hurricane is an example of a very strong thermal. Thermal outer boundaries have slightly lower air pressure and slightly higher temperature than the surrounding air, so there is some slight lift there. The core of the thermal (the center of the column) has the lowest local air pressure and the highest temperature in the thermal, and this part of the thermal has the strongest lift. As such, this part streams upward fastest, compared to the outer portion of the thermal. In other words, the lift is strongest and hottest in the center of a thermal. Ideally, the aerial vehicle pilot or the autopilot is able to identify a thermal and spin in this thermal in a helical path, just like certain birds do, closest to the thermal center. FIG. 5 is an example of thermaling in the highest lift location possible. It is obviously impossible to spin in the thermal core, as this is a point location, but it is possible to spin as close to the core as possible, with a smallest possible turn radius.

Ridge lift (shown in FIG. 6) is created by wind, impacting a discontinuity such as a ridge, and being diverted upward, streaming with the curve of the obstruction, creating a vector of air that moving up, i.e., a lift source. In general, the strongest lift can be found just above the highest point of the ridge, and gets weaker in both directions, with the boundaries of lines X and Y. As opposed to thermal lift, ridge lift is composed of air that is not hotter than its surrounding air. Indeed, the air in ridge lift is sometimes even cooler than its surrounding air, e.g., if it is wind arriving from the sea, hitting a shore ridge.

This fact can be used to identify the type of lift and how to locate the maximum lift, by tracking the highest peak of the ridge. When the aerial vehicle crosses lift, it can gauge if it is ridge lift, identify the strongest lift within the lines X and Y in FIG. 6, and maneuver to stay in the strongest lift (with prediction on the ridge line path). This can greatly help the pilot and autopilot. Information derived from geographical data bases can be used to geographically understand the ridge structure, and to use it in predicting where the ridge goes, to find the best lift.

The present aids in locating regions of air lift, predicting its future motion, and optionally modifying calculations and predictions based on sensors readings. In an embodiment, the system operates to gain height and stay aloft for as long as possible. Lift and the direction to the best lift location may be identified by using multiple variometers and/or accelerator sensors, with the help of a temperature sensor.

The use of a variometer and/or vertical accelerator sensor (in the Z axis, sensing upward or downward motion) in various locations allows better Z axis motion detection, such that motion created by air lift can be sensed in various part of the aerial vehicles. In an embodiment, these variometer and/or accelerometer sensors are located in the wings tips. In the case of unpowered aerial vehicles, the only way to gain height is by using air lift—air that streams upward. As noted above, there are several sources of lift, e.g., thermal lift, mountain or ridge lift, “weather front” lift, “cloud waves” lift etc. All of these types of lift are supported within the invention. Powered aerial vehicles may also implement this invention in order to lower flight cost, conserve fuel, lower engine use and provide a generally quieter flight.

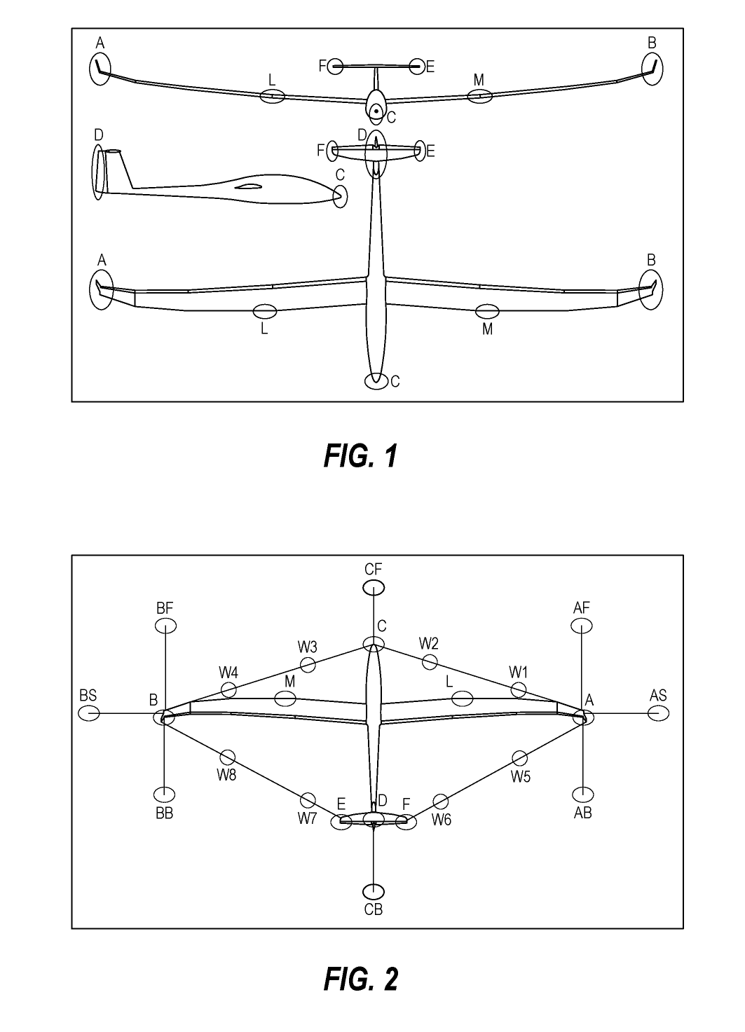

Implementation may include installing a variometer sensor and/or accelerator sensor on each of the glider's wing tips, e.g., 2 variometer sensors and/or 2 accelerometer sensors. This minimum solution (a sensor on each wing tip) may provide data on entering lift (such as it is done today, with a single variometer located in the center of aerial vehicles), but with the benefit of a wider detection area, as well as directionality as to where the lift is detected, (i.e., to the left or right of the vehicle) to direct the pilot or autopilot to turn into the lift. This solution is best optimized for parafoils, paragliders or speedflying type aerial vehicle, as these 2 points are located far enough from each other to the sides, so lift resolution will be sufficient. An alternative entails installing a sensor such as described in FIGS. 1 and 2, wherein sensors are located on the aerial vehicle skin and also off the glider as described in FIG. 2. Sensor data may be used to artificially compose a lift map that may then be shown on the pilot screen, to be used by the pilot as guidance, or it may be used by the autopilot to automatically drive the aerial vehicle to the best lift detected. This information can also be transmitted to other neighboring pilots or unmanned aerial vehicles in the area, or may be stored in a database for use in learning about the area weather, over days, weeks, months, seasons and years to obtain statistical lift data.

A temperature sensor may be placed in every location a variometer and/or accelerometer is located, to check the air stream temperature. This may be used to identify if the air streaming up is a thermal (air that is usually hotter than the surrounding air) or ridge lift, where the air streaming up is usually the same temperature as the surrounding air, or cooler than the surrounding air. This temperature data can be used by the autopilot to select an appropriate lift algorithm, e.g., a thermal algorithm or a ridge algorithm. The thermal algorithm identifies the center of a thermal column, whereas the ridge algorithm identifies a path of lift along the ridge.

Additional sensor locations on the aerial vehicle skin may be used to gain a finer reading of the air pressure around the aerial vehicle. This embodiment can be seen in FIG. 1, specifically locations A, B, C, D, E, F, L and M. Moreover, to gain a better resolution of the lift map, one or more variometer sensors may be installed outside the outline of the aerial vehicle, on wires connecting the aerial vehicle nose to each of the wing tips and wires connecting the aerial vehicle rear point to each of the wing tips. Sensors may also be placed on foldable extending rods (such as long pipes, extending to the front, back and sides of the aerial vehicle etc.) to gauge air pressure far forward, far backward and to the sides, to get a wider and more detailed air lift map of the air surrounding the aerial vehicle.

An example of such an implementation may be seen in FIG. 2. These extenders may be foldable, to reduce drag while they are not used, such as during take-off, landing and so on. The sensors' outputs (data produced by sensors) are routed to an on-board computer. The computer gathers all sensors data and calculates and draws a virtual current air lift map around the aerial vehicle. This may be done continuously (e.g., numerous times per second) to gauge changes and make an informed decision based on it. The computer calculates the lift rate per sensor, and determines if the aerial vehicle is moving into the lift center (strongest lift), if it is straight ahead, or to the right or to the left of aerial vehicle nose, and provide directional recommendation to the pilot to fly to the strongest lift direction or fly the aerial vehicle to the better lift, in an auto-pilot operation.

The aerial vehicle may have a global positioning sensor such as GPS to define its current location and a barometric air pressure sensor on board to determine altitude. Since each variometer/accelerometer sensor is located at a fixed location relative to the aerial vehicle, known to the computer, the computer has the location of each sensor in space at any moment. Given this, an instantaneous detailed lift map may be calculated by the on-board computer and can be continuously updated, to cover a larger area that the aerial vehicle was traveling through in a particular flight.

Artificial intelligence can be employed in this process to process all past information for the current location, and provide a best estimate of the motion of the lift direction, over time, to help and guide the pilot or autopilot. Corrections may than be applied, in real time, to compare the best estimate with current conditions and make a correction for the next point to fly to. The current lift map can be based on current sensor and GPS data and in addition, processed historical information in this area, to fine tune the next path to fly to, i.e., the next point of best lift.

In the case of manned flight, the lift map may be processed to provide the pilot with a reliable indication, e.g., via a visual on a special screen and/or an audio signal, emitting different signals to indicate when and in which direction to turn and in what bank, to find better lift. When the autopilot is controlling the aerial vehicle, the decision is made by the computer, and the direction to fly is executed by the autopilot (the computer). If the current start point is quiet air (e.g., substantially no lift), a single sensor indicating lower air pressure (going up) and/or wing tip movement (indicated by the relevant accelerometer sensor) and optionally the air temperature is a bit higher than the other aerial vehicle surrounding air, is a sign that a first thermal may be sensed.

It may take a few continuous lift maps and more sensors indicating they are also in a lower pressure area, to identify if it is real lift or just a small air bubble streaming up. If lift is starting to be sensed in neighboring sensors, continuously for several seconds, the computer determines that actual lift has been detected and its direction is identified. The pilot or autopilot now will be informed on the direction to this lift, thus directing them, including the angle of bank, to the best lift.

In a significant embodiment, reliable lift data is provided to the pilot or autopilot. If it is a pilot, he or she will have the option to activate the optional “autopilot” mode of the on-board computer, which will automatically fly into the strongest lift, based on the multiple variometer structure and/or the multiple accelerometer structure, the base for this patent application. If the aerial vehicle flies in an area with several sources of lift (such as a dense thermic field) that were identified by the computer, the pilot or autopilot are directed to the center of the strongest lift, the one with the core which has the strongest lift—such as the strongest thermal.

Lift maps may be shared with other aerial vehicles in the area over wireless communication channels, for the other aerial vehicle's computer to evaluate. Computers that get such lift data from a neighboring aerial vehicle computer, may decide to recommend to its pilot to join the neighboring aerial vehicle in its lift, as it may be more promising than the lift map it is in. This is the same action an autopilot may take, making a decision to leave current lift and join the better lift, in accordance with the lift map it just received. Joining neighboring aerial vehicle in its lift will be based on the clear “right of way” rules, used in air traffic.

Lift maps can be continuously sent to a base station that stores the data, for farther processing, such as to provide lift statistics over the time of day, date, location, season etc., for use by pilots while planning flights. Artificial Intelligence may be used to extract data from the historical lift maps.

Unpowered aerial vehicles, using this invention, may employ solar panels, mounted on the wings and optionally on the fuselage, to power aerial vehicle on-board electronics, charge a battery (to continue powering the on-board electronics when sun is hidden, such as by clouds or mountain shadows) and in some cases to power an optional motor and propeller. Unpowered aerial vehicle that rely on meteorological conditions may be forced to land if unable to find adequate lift. To overcome this unreliability issue and to elevate reliability in performing its task (if a task is assigned to it), this invention also defines a flight formation of a swarm or group of unpowered aerial vehicles with a task assigned to each of the aerial vehicles. If one of the vehicles needs to land, its assignment will be reassigned to other, neighboring aerial vehicles or, if needed, a new such aerial vehicle will be launched, to replace the aerial vehicle that was forced to land.

FIG. 1 describes sensors locations. All variometer sensors should be placed as to gauge static pressure, hidden from the dynamic pressure created by air flow on the skin of the aerial vehicle. Variometer, accelerometers and temperature sensors may be placed in the locations shown in FIG. 1, namely locations A, B, C, D E, F, L and M. This will ensure a detailed lift map. However, the minimum number of sensors, to allow using this implementation, is 2, e.g., one sensor at the tip of each wing. This may include one variometer, one accelerometer and one temperature sensor on each wing tip, in locations A and B.

FIG. 2 shows all sensors as in FIG. 1, with additional sensors, located outside of the body of the aerial vehicle, on wires or extending rods, further away from the vehicle skin. This provides data for a better and wider lift sensing abilities, for a detailed and wider lift map. This will be especially beneficial on days when thermals are less dense and more scattered; having a larger area for sensing lift contributes to better lift identification and may thus provide additional flight time. The ability to locate lift with sensors located on the extended rods is even better, but depends on the length of the rods and the gains provided by the additional data may be at least partially offset by the aerodynamic drag these rods create.

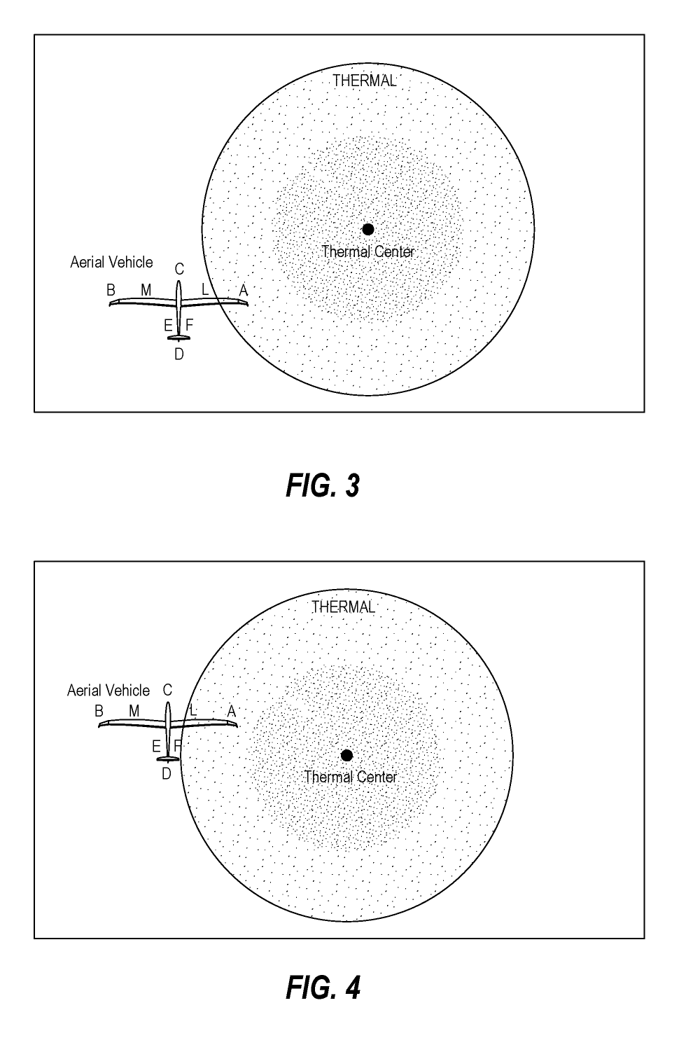

In both FIG. 1 and FIG. 2, accelerator sensors may be placed in locations A and B and optionally at points C and D, to sense the lifting of the wings, nose and tail, upon entering the boundaries of a lift location. As FIG. 3 shows, when part of the wing enters a thermal (such as the right wing, location A), this wing is lifted. This lift can be identified by the variometer sensor, but also by the accelerator sensor, to show the real lift rate, not only the lower air pressure. This will provide a better, finer measurement for the computer, to provide a more informed decision for the pilot or autopilot to turn into lift.

In both FIG. 1 and FIG. 2, temperature sensors may be placed in locations A and B and optionally at points C and D, to sense the air temperature at the wing tips and optionally, the nose and tail, when entering the boundaries of a hot air (thermal). As FIG. 3 shows, when part of the wing enters a thermal (such as the right wing, location A), this wing tip is inside of a thermal, while the other wing tip and all the rest of sensor measure surrounding are temperature. This is a clear indication that wing tip A is in thermal lift and not ridge lift.

FIG. 3 shows a thermal (the dark circle on the right side of the picture, where a darker color signals a stronger lift), and an aerial vehicle with part of its right wing in the thermal. In this case, a variometer sensor in location A report lowered air pressure and the accelerator sensor reports that the wing is moving upward. If no other sensor reports similar changes, the computer makes a note that the tip of the right wing is within lift. Also, while traveling forward, variometer sensor A reports a lower pressure and the accelerator sensor reports the right wing tip accelerating upward, and the temperature sensor reports increasing air temperature. This occurs as the 3 sensors in location A are traveling within the thermal, getting closer to its center, where air pressure is lower and lift is higher and temperature is getting higher. This information, collected in a few consecutive lift maps, can be used to calculate the lift center location, and point the pilot or autopilot into it.

While the aerial vehicle continues flying forward, sensor group L in FIG. 4 will enter the thermal, and will report to the computer data indicating that sensor group L is within a thermal. Now the lift map will be based on 2 sensors (A and L), and over time, the lift map image within the computer will be more detailed and accurate.

FIG. 3 is an extreme example, where only one sensor (sensors in wing tip A in this example) enters the thermal, then the second variometer sensor enters, as in FIG. 4, and the computer has a relatively small amount of data to make a decision, but this may be enough. It can draw an educated lift map and tentatively identify the lift center for the pilot/autopilot. If the gilder crosses the thermal closer to the center, more sensors will feel (and report) the lift, each in its location. Here, the computer has much more information, the lift map will be more detailed and more reliable, and hence the recommendation to the pilot/autopilot will be more reliable.

The sensors in FIG. 3 will sense pressure getting lower while the aerial vehicle crossing, until the point where its' right wing tip is aligned with the center of the thermal. Once the aerial vehicle passes this point, such as in FIG. 4, the air pressure sensed in sensors A and L will start increasing, meaning the sensors feel lower lift. This is an important point, as now the gilder computer has found the maximum lift, so its right-wing points to the thermal center and now lift is getting lower, and it should now recommend to the pilot/autopilot to start turning to the right, in order to stay in the thermal (lift), and not just cross it and exit the lift area.

If more sensor groups enter into a thermal (such as sensor groups F, D, C, E etc. in FIG. 4), the computer will generate a lift map that will be much more detailed and accurate. This is achieved by the glider algorithm, to turn right, in this example. This section explains the algorithm using the right wing entering the thermal as an example, but it is the same process for a thermal if the left side enters the thermal. In the odd case where the glider enters the thermal centered and head on, upon passing the thermal (where air pressure starts rising), it may turn to the right or to the left; wherever it senses a slightly higher lift.

Optimally, when the computer has generated a few consecutive lift maps, showing a reliable and stable air pressure increase, meaning the lift is getting lower, this is the point that the computer recommends that the pilot/autopilot starts turning sharp into the lift, to stay in the thermal. If pilot does not react, the aerial vehicle will exit the lift. In this case, since the lift map is stored in the on-board computer memory, the computer continues recommending that the pilot return to the previous thermal area, while also searching for new lift.

An optimal flight path to gain the best lift and height in a current thermal is shown in FIG. 5. The computer shows the direction to: 1. have all its on-board sensors within the thermal, so all vehicles' wing surfaces are creating lift, for best height gaining and 2. spin closest to the thermal center, where lift is strongest, turning in the smallest radius which the aerial vehicle is able to accomplish and the pilot (if it is a manned flight) to able to withstand. This should create a path as shown in FIG. 5 and gain maximum height from a current thermal.

The aerial vehicle computer may share the collection of the latest lift maps with other aerial vehicles' computers (using wireless communication), to allow the other aerial vehicles' computers to evaluate, and perhaps provide recommendations to their pilots on promising lift locations.

Lift maps may be shared with base station or a computing cloud, to be stored and processed. Data from this big collection are statistics on typical thermals created at specific location in a specific period of the year (They are also known as “house thermals” in the unpowered aerial vehicle community). This data may be processed by artificial intelligence means, to provide the best estimation on the next lift location. This data will be fed into the aerial vehicle computer of novice pilots, to help them stay aloft more time, getting recommendation for the history of thermal, on top of current invention recommendation.

Lift generated by wind hitting a ridge, creating air lift, can be tracked via a similar method, i.e., using variometer sensors and/or accelerometer sensors on the wing tips in the aerial vehicle, where the aerial vehicle will identify lift, recommend to the pilot to turn into the lift, identify if it is not a round thermal, but ridge lift, search for the highest lift path on all sensors and recommend the pilot/autopilot to stay in this path. Ridge lift is generally in a straight line, but this line is tracking geographical changes, such as a valley, ridge turn etc.

The discussion is mainly for unpowered aerial vehicles, but it is perfectly relevant to powered aerial vehicle as well, i.e., to gain height while conserving fuel, allowing engines to idle or be stopped, and to provide generally quieter and cheaper operation. It will be appreciated that various systems and processes have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method comprising using two variometer/pressure sensors in an aerial vehicle, located on opposite wing tips, to compare lift on the aerial vehicle's wing tips and find a direction to a lift field based on differential air lift read by the sensors.

2. The method of claim 1 further comprising using more than 2 variometer/pressure sensors on aerial vehicle, locating them on the aerial vehicle in predetermined areas, to generate a more detailed lift map around the aerial vehicle showing lift strength in sensor locations.

3. The method of claim 2 including the use of further additional variometer/pressure sensors in aerial vehicles located on the end of extender rods.

4. The method of claim 3 wherein the extender rods are foldable, and extend to the front, back and sides of the aerial vehicle wings, to provide a wider and more detailed lift map around the aerial vehicle.

5. The method of claim 3 further including using temperature sensors, paired with the variometer/pressure sensors to get more information on the lift type and nature.

6. The method of claim 5, wherein using temperature sensors, paired with the variometer/pressure sensors to get more information on the lift type and nature further comprises identifying the lift as thermal lift or ridge lift based on the sensed temperature.

7. A method comprising:
using an accelerometer sensor, paired with a variometer/pressure sensor and temperature sensor, to obtain information on the dynamic nature of lift by calculating 2^{nd} and 3^{rd} derivatives of the acceleration; and
refining an algorithm of a lift map using the information on the dynamic nature of the lift.

8. The method of any of claims 3, 4, 5 and 6 wherein the aerial vehicle is an unpowered aerial vehicle.

9. The method of any of claims 3, 4, 5 and 6 wherein the aerial vehicle is a powered aerial vehicle.

10. The method according to either of claims 6 and 7 used within a fully in-air autonomous autopilot to run in an on-board computer and/or remote computer to keep the aerial vehicle aloft.

11. The method according to claim 10, wherein the aerial vehicle further comprises a “swarm” of powered or unpowered aerial vehicles for predefined task or flight.

12. The method according to claim 11, wherein the swarm is managed from a ground control station.

13. The method according to claim 11, wherein the swarm is managed by one or more members of the swarm.
